(19) United States
(12) Patent Application Publication
(10) Pub. No.: US 2011/0240309 A1
(43) Pub. Date: Oct. 6, 2011

(54) COMPOSITION SUITABLE FOR PRODUCTION OF FOAM EXTINGUISHANTS

(76) Inventors: Arend Jouke Kingma, Ludwigshafen (DE); Astrid Schmidt Prestewitz, Prestewitz (DE); Ulrich Steinbrenner, Neustadt (DE); Thomas Leonhardt, Schifferstadt (DE); Gerhard Ruhle, Landenburg (DE); Cihan Sahin, Heddesheim (DE); Veronika Weigelt, Ludwigshafen/RH. (DE)

(21) Appl. No.: 12/916,415

(22) Filed: Oct. 29, 2010

Related U.S. Application Data
(60) Provisional application No. 61/377,904, filed on Aug. 27, 2010.
(60) Provisional application No. 61/378,963, filed on Sep. 1, 2010.
(60) Provisional application No. 61/380,019, filed on Sep. 3, 2010.
(60) Provisional application No. 61/381,386, filed on Sep. 9, 2010.

(30) Foreign Application Priority Data
Oct. 30, 2009 (EP) EP09013702.7
Jun. 6, 2010 (EP) EP10005847.8
Sep. 1, 2010 (EP) EP10174943.0

(51) Int. Cl. E21B 43/00; A62D 1/02; C08L 35/00; C08L 33/26; C08L 33/14; C08L 33/08

(52) U.S. Cl. 166/369; 252/3

(57) ABSTRACT

The present invention relates to compositions for foam extinguishants which do not comprise any organofluorine compounds and nevertheless meet the highest demands on the extinguishing properties. The inventive compositions comprise at least one fatty alcohol, at least one thickener and at least one acrylic polymer, but the composition does not comprise any organohalogen compounds, more particularly any organofluorine compounds. The present invention also relates to the use of such a composition for production of a foam extinguishant and to the use of the composition for fighting fires, especially for fighting fires of organic liquids, known as liquid fires.

This application claims priority to U.S. Provisional Patent Application No. 61/377,904, filed Aug. 27, 2010; U.S. Provisional Patent Application No. 61/380,019, filed Sep. 3, 2010; U.S. Provisional Patent Application No. 61/381,386, filed Sep. 9, 2010; EP Application No. EP09013702.7, filed Oct. 30, 2009; EP Application No. EP10005847.8, filed Jun. 6, 2010; EP Application No. EP10174943.0, filed Sep. 1, 2010; U.S. Provisional Patent Application No. 61/378,963, filed Sep. 1, 2010 and International Application No. ______, filed Oct. 29, 2010 in the European Receiving Office and entitled “Composition Suitable for Production of Foam Extinguishants”, the contents of each of which are hereby incorporated by reference in their entireties.

### BACKGROUND

The present invention relates to compositions for foam extinguishants which do not comprise any organofluorine compounds and nevertheless meet the highest demands on the extinguishing properties.

The use of organofluorine compounds is widespread in extinguishants, especially foam extinguishants, in which so-called Fluorosurfactants assume absolutely essential functions. Fluorosurfactants increase the extinguishing capacity of foam extinguishants, especially on liquid and water-immiscible substances. Here, the use of the fluorosurfactants is instrumental for the ability to extinguish even the largest fires efficiently, or in some cases at all.

Typically, extinguishants are formulated in the form of aqueous concentrates which, when employed, are diluted with water and foamed to a foam. In order that the foam remains stable during the extinguishing operation, it is generally necessary to add a thickener, preferably a polysaccharide, to the concentrate. The problem arises here that relatively large concentrations of thickener lead to an undesired increase in viscosity of the concentrate.

EP 595772 A1 proposes extinguishants which, in addition to at least one fluorosurfactant, comprise a polysaccharide as a thickener and a water-soluble anionic copolymer.

However, there are efforts to avoid the use of such fluorosurfactants, and that of organofluorine compounds quite generally, since these compounds often are not biodegradable and can accumulate in the environment, and are considered to be potentially damaging to the environment and to health. However, a substitute for these substances without significant losses in extinguishment performance is not known at present.

U.S. Pat. No. 6,845,823 B2 describes fluorine-free foam extinguishants which necessarily comprise a combination of five ingredients. Essential components of the compositions disclosed therein are specific polyoxyalkylenediamines and polyoxyethylene fatty acid monoethanolamide phosphate esters.

WO 03/049813 A1 discloses fluorine-free aqueous foam compositions which can be used as foam extinguishants. The compositions disclosed therein comprise caramelized saccharides as an essential constituent, in addition to the fluorine-free organic surfactants necessary for foam formation.

Similar compositions are also disclosed in WO 2006/094077. Also essential here is the obligatory use of caramelized saccharides and/or other polysaccharide-like compounds in combination with a crosslinker.

WO 2004/112907 A2 discloses extinguishants, for example foam-forming aqueous concentrates. These necessarily comprise a high molecular weight acidic polymer and a coordinating salt in an amount of preferably 4 to 40% by weight, and also the stabilizers customary for foam formation and optionally a thickener. The coordinating salts are especially magnesium sulfate and magnesium nitrate, and the acidic polymers are polymers with carboxylic acid groups or other functional acid groups, such as sulfo groups and phospho groups. According to the technical teaching of WO 2004/112907, these acidic polymers are used in an amount of up to about 6% by weight. To achieve satisfactory extinguishing action, it is necessary to use comparatively large amounts of coordinating salts.

WO 2006/122946 A1 discloses the use of aqueous compositions of water-soluble and/or water-swellable polymers and water-soluble neutralizing agents as an addition to aqueous extinguishants.

However, there is still the problem that there are no known fluorine-free foam extinguishants which reliably achieve the highest extinguishment performance classes, especially on fires of water-immiscible substances.

### OBJECT OF THE INVENTION

It is therefore an object of the present invention to provide a composition free of fluorosurfactants, i.e. organofluorine compounds, which is suitable for production of foam extinguishants, while still satisfying high extinguishment performance class requirements, for example according to EN 1568:2008, especially parts 3 and 4.

### BRIEF DESCRIPTION OF THE INVENTION

According to the invention, this object is achieved by an aqueous composition according to claim 1. The present invention thus provides a composition which is suitable for provision of foam extinguishants and is based on an aqueous composition which comprises a mixture of at least one fatty alcohol, at least one thickener and at least one acrylic polymer, said composition not comprising any organohalogen compounds, more particularly any organofluorine compounds. Organohalogen compounds (including organofluorine compounds) are compounds having covalent bonds between carbon and halogen, for example having covalent bonds between carbon and fluorine (C—F bonds) in the case of organofluorine compounds.

Accordingly, the present invention relates to a composition which is suitable for production of foam extinguishants and which comprises the following constituents:
i) at least one fatty alcohol,
ii) at least one acrylic polymer,
iii) at least one thickener and
iv) water,
   wherein said composition does not comprise any organofluorine compounds, more particularly any organohalogen compounds.

The present invention also relates to the use of a composition as described here and in the claims for production of a foam extinguishant.

The present invention also relates to the use of a composition as described here and in the claims for fighting fires, especially for fighting fires of organic liquids, known as liquid fires.

The present invention further relates to a method for fighting fires, especially for fighting liquid fires, comprising:

diluting an inventive composition with water

foaming the diluted composition thus obtained to give a foam extinguishant and

applying the foam extinguishant to the seat of fire or to sites which are to be protected from a fire.

The present invention further relates to an apparatus for deploying a foam extinguishant, comprising the inventive composition as described here and in the claims. The present invention further relates to the use of an inventive composition in the form of a foam for covering volatile organic substances, especially volatile organic liquids. In this case, an inventive composition is foamed and the foam is applied to the surface of the organic liquid, for example in the form of a foam carpet, such that the liquid is covered by the foam.

The present invention also relates to the use of an inventive composition in liquid form or in the form of a foam in the extraction of fossil fuels from natural underground deposits.

The present invention also relates to a method for extracting fossil fuels from natural underground deposits present in rock formations, which comprises the introduction of an aqueous liquid which comprises an inventive composition into the underground deposits.

### DETAILED DESCRIPTION OF THE INVENTION

The inventive composition, also referred to hereinafter as inventive formulation, can achieve provision of foam extinguishants which reliably meet high demands on extinguishment performance. High extinguishment performances can be demonstrated, for example, according to EN 1568:2008, especially part 3 and 4, and these high extinguishment performances can be categorized into class 1 which comprises burnback resistance classes A to C. Inventive compositions attain extinguishment classes of category 1A or 1B, as defined above, especially for extinguishment performance classes according to EN 1568:2008 part 3, and 1A to 1C according to part 4.

The inventive compositions are typically pseudoplastic compositions in which the viscosity depends not only on the temperature but also on the shear rate. Nevertheless, the inventive compositions typically exhibit flow behavior which enables, in a reliable manner, reliable deployment of foam extinguishants with the extinguishing equipment typically available to fire departments. The inventive compositions have a suitable viscosity for production of foam extinguishants, generally a viscosity of not more than 4000 mPa·s at 20° C. and a shear rate of 100/min, frequently of not more than 1000 mPa·s at 20° C. and a shear rate of 100/min, for example a viscosity in the range from 150 to 4000 mPa·s or in the range from 150 to 2000 mPa·s, at 20° C. and a shear rate of 100/min, more particularly a viscosity in the region of less than 750 mPa·s at 20° C. and a shear rate of 100/min, especially a viscosity of 150 to 450 mPa·s, more preferably 200 to 400 mPa·s, and especially preferably 250 to 400 mPa·s, at 20° C. and a shear rate of 100/min (viscosity is determined with a HAAKE-Thermo RV1 rotational viscometer, at 20° C., shear rate 100/min; evaluation: RheoWin 3.0, cone-plate geometry, cone: diameter 60 mm with 1° slope, measurement procedure according to EN 1568:2008).

The inventive composition comprises at least one fatty alcohol. Fatty alcohols in the context of the present invention are alcohols having at least 6 carbon atoms, especially having 8-20 carbon atoms and more preferably having 8-16 or 12-14 carbon atoms, and one hydroxyl functionality, i.e. one hydroxyl group per molecule. Preference is given to fatty alcohols with a terminal hydroxyl group, and especially fatty alcohols with straight-chain and saturated alkyl radicals, preferably having more than 6 carbon atoms, especially preferably 8-20 carbon atoms and more preferably 8-16 or 12-14 carbon atoms. Particularly preferred examples of fatty alcohols for use in accordance with the invention are octyl alcohol, lauryl alcohol and myristyl alcohol, including mixtures thereof. The at least one fatty alcohol is used in the inventive composition typically in an amount of 0.5 to 4% by weight, more preferably 1 to 3% by weight, and especially in an amount of 1.5 to 2.5% by weight (all percentages by weight are based on the total weight of the composition). The fatty acid component of the composition enables the viscosity to be varied without impairing the overall stability of the composition. More particularly, and contrary to the prejudice in the art, it has been found that, surprisingly, the fatty alcohol component does not cause any precipitation of the polysaccharide components of the composition.

In addition, the inventive composition comprises at least one acrylic polymer. Acrylic polymers in the context of the invention are understood to mean polymers which are formed from ethylenically unsaturated monomers M and which comprise monomers derived from acrylic acid in copolymerized form. The monomers derived from acrylic acid include, aside from acrylic acid, all monomers which have at least one, for example one or two, carboxyl group bonded to an ethylenically unsaturated double bond, for example methacrylic acid, maleic acid, fumaric acid, itaconic acid and citraconic acid. In addition to acrylic acid and the monomers derived from acrylic acid, the acrylic polymers may also comprise monomers in copolymerized form, said monomers being derivatives, especially esters, amides or anhydrides, of acrylic acid, or corresponding derivatives of the monomers derived from acrylic acid. The total amount of monomers derived from acrylic acid and derivatives thereof is typically at least 50% by weight, especially at least 70% by weight, based on the total amount of the ethylenically unsaturated monomers which constitute the acrylic polymer.

Suitable acrylic polymers which can be used in accordance with the invention are especially those disclosed in EP 412389, EP 498634, EP-A-554 074, EP-A-1158 009, DE 3730885, DE 3926168, DE 3931039, DE 4402029, DE 10251141, DE 19810404, JP-A-56-81 320, JP-A-57-84 794, JP-A-57-185 308, U.S. Pat. No. 4,395,524, U.S. Pat. No. 4,414,370, U.S. Pat. No. 4,529,787, U.S. Pat. No. 4,546,160, U.S. Pat. No. 6,858,678, U.S. Pat. No. 6,355,727, WO 2006/122946 A1, WO 2006/134140, WO 2008/058921, WO 2009/019148 and WO 2009/0062994. These patent applications are hereby fully incorporated by reference. Particularly suitable acrylic polymers for use in accordance with the invention are the polymers AP1 to AP15 cited hereinafter, which, according to the pH of the formulation, may be present in nonneutralized, partly neutralized or fully neutralized form. Further suitable acrylic polymers are the products commerically available under the trade names Sokalan® AT, Sokalan® CP, Sokalan® HP, Sokalan® PM, Sokalan® PA, Sokalan® ES, Sterocoll® D, Sterocoll® FD, Sterocoll® HT, Sterocoll® FS, Densodrin® BA and Densotan® A from BASF SE.

The acrylic polymer for use in accordance with the invention is typically used in amounts of 0.1 to 5% by weight and frequently in amounts of 0.2 to 2.5% by weight, based in each case on the total weight of the concentrate. In particular, it is used in amounts of 0.5 to 2.0% by weight and more preferably in amounts of 1.00 to 1.75% by weight, based in each case on the total weight of the concentrate. It will be appreciated that it is also possible to use mixtures of acrylic polymers.

For the inventive compositions and use thereof, it has been found to be advantageous when the acrylic polymers have a number-average molecular weight in the range from 1500 to 150 000 daltons, especially in the range from 2000 to 100 000 daltons.

Acrylic polymers preferred in accordance with the invention are copolymers formed from units of polymerized monoethylenically unsaturated monomers M, comprising:

at least one monomer A selected from monoethylenically unsaturated mono- and dicarboxylic acids having 3 to 8 carbon atoms and the internal anhydrides of monoethylenically unsaturated dicarboxylic acids having 3 to 8 carbon atoms, and

at least one monomer B selected from uncharged nonionic monoethylenically unsaturated monomers.

Examples of monomers A are monoethylenically unsaturated monocarboxylic acids having 3 to 8 carbon atoms, such as acrylic acid, methacrylic acid, vinylacetic acid and crotonic acid, and monoethylenically unsaturated dicarboxylic acids having 4 to 8 carbon atoms, such as maleic acid, fumaric acid, itaconic acid, citraconic acid and the like, and the internal anhydrides of the aforementioned dicarboxylic acids, such as maleic anhydride and itaconic anhydride. The acrylic polymer preferably comprises the monomers A copolymerized in the form of the acids or salts thereof. Preferred monomers are the aforementioned monoethylenically unsaturated monocarboxylic acids and, among these, more preferably acrylic acid and methacrylic acid and mixtures thereof. Preferred monomers A are also mixtures of at least one monoethylenically unsaturated monocarboxylic acid, which is especially selected from acrylic acid and methacrylic acid and mixtures thereof, with at least one monoethylenically unsaturated dicarboxylic acid, which is especially selected from maleic acid, for example mixtures of acrylic acid with maleic acid, methacrylic acid with maleic acid, and acrylic acid with methacrylic acid and with maleic acid.

Examples of suitable monomers B are firstly uncharged monoethylenically unsaturated monomers B′ with a limited water solubility of generally not more than 50 g/l, especially not more than 30 g/l. These include:

esters of monoethylenically unsaturated C₃-C₆-monocarboxylic acids with C₁-C₂₀-alkanols, C₅-C₈-cycloalkanols, phenyl-C₁-C₄-alkanols or phenoxy-C₁-C₄-alkanols, especially the aforementioned esters of acrylic acid and the aforementioned esters of methacrylic acid;

diesters of monoethylenically unsaturated C₄-C₆-dicarboxylic acids with C₁-C₂₀-alkanols, C₅-C₈-cycloalkanols, phenyl-C₁-C₄-alkanols or phenoxy-C₁-C₄-alkanols, especially the aforementioned esters of maleic acid;

vinylaromatic hydrocarbons, for example styrene, vinyltoluenes, tert-butylstyrene, α-methylstyrene and the like, especially styrene;

vinyl, allyl and methallyl esters of saturated aliphatic C₂-C₁₈ monocarboxylic acids, such as vinyl acetate and vinyl propionate, and

α-olefins having 2 to 20 carbon atoms, and conjugated diolefins such as butadiene and isoprene.

The prefixes Cₙ-Cₘ used here and hereinafter indicate a range for the possible number of carbon atoms that a radical thus designated or a compound thus designated may have in each case.

For example, C₁-C₃₀-alkyl, C₁-C₂₀-alkyl, C₁-C₁₀-alkyl and C₁-C₄-alkyl represent a linear or branched, saturated alkyl radical having, respectively, 1 to 30, 1 to 20, 1 to 10 and 1 to 4 carbon atoms.

For example C₃-C₃₀-alkenyl, C₃-C₂₀-alkenyl, C₃-C₁₀-alkenyl and C₃-C₄-alkenyl represent a linear or branched, mono- or polyunsaturated, for example mono-, di- or triunsaturated, hydrocarbon radical having, respectively, 3 to 30, 3 to 20, 3 to 10 and 3 to 4 carbon atoms.

For example, C₅-C₈-cycloalkanol represents a monohydric cycloaliphatic alcohol having 5 to 8 carbon atoms, for example cyclopentanol, cyclohexanol, cycloheptanol, methylcyclohexanol or cyclooctanol.

For example, C₅-C₈-cycloalkyl represents a monovalent cycloaliphatic radical having 5 to 8 carbon atoms, for example cyclopentyl, cyclohexyl, cycloheptyl, methylcyclohexyl or cyclooctyl.

For example, phenyl-C₁-C₄-alkanol and phenoxy-C₁-C₄-alkanol represent, respectively, a phenyl- and phenoxy-substituted monohydric alkanol where the alkanol moiety has 1 to 4 carbon atoms. Examples of phenyl-C₁-C₄-alkanol are benzyl alcohol, 1-phenylethanol and 2-phenylethanol. An example of phenoxy-C₁-C₄-alkanol is 2-phenoxyethanol.

For example, phenyl-C₁-C₄-alkyl and phenoxy-C₁-C₄-alkyl represent, respectively, a phenyl- and phenoxy-substituted alkyl group where the alkyl moiety has 1 to 4 carbon atoms. Examples of phenyl-C₁-C₄-alkyl are benzyl, 1-phenylethyl and 2-phenylethyl. An example of phenoxy-C₁-C₄-alkyl is 2-phenoxyethyl.

Examples of esters of monoethylenically unsaturated C₃-C₆-monocarboxylic acids with C₁-C₂₀-alkanols, C₅-C₈-cycloalkanols, phenyl-C₁-C₄-alkanols or phenoxy-C₁-C₄-alkanols are especially the esters of acrylic acid, such as methyl acrylate, ethyl acrylate, n-propyl acrylate, isopropyl acrylate, n-butyl acrylate, 2-butyl acrylate, isobutyl acrylate, tert-butyl acrylate, n-hexyl acryate, 2-ethylhexyl acrylate, 3-propylheptyl acrylate, decyl acrylate, lauryl acrylate, stearyl acrylate, cyclohexyl acrylate, benzyl acrylate, 2-phenylethyl acrylate, 1-phenylethyl acrylate, 2-phenoxyethyl acrylate, and also the esters of methacrylic acid, such as methyl methacrylate, ethyl methacrylate, n-propyl methacrylate isopropyl methacrylate, n-butyl methacrylate, 2-butyl methacrylate, isobutyl methacrylate tert-butyl methacrylate, n-hexyl methacrylate, 2-ethylhexyl methacrylate, decyl methacrylate, lauryl methacrylate, stearyl methacrylate, cyclohexyl methacrylate, benzyl methacrylate, 2-phenylethyl methacrylate, 1-phenylethyl methacrylate and 2-phenoxyethyl methacrylate.

Examples of diesters of monoethylenically unsaturated C₄-C₆-dicarboxylic acids with C₁-C₂₀-alkanols, C₅-C₈-cycloalkanols, phenyl-C₁-C₄-alkanols or phenoxy-C₁-C₄-alkanols are especially the diesters of maleic acid and the diesters of fumaric acid, especially di-C₁-C₂₀-alkyl maleates and di-C₁-C₂₀-alkyl fumarates, such as dimethyl maleate, diethyl maleate, di-n-butyl maleate, dimethyl fumarate, diethyl fumarate and di-n-butyl fumarate.

Examples of vinyl, allyl and methallyl esters of saturated aliphatic C₂-C₁₈ monocarboxylic acids are vinyl acetate, vinyl propionate, vinyl butyrate, vinyl pivalate, vinyl hexanoate, vinyl-2-ethyl hexanoate, vinyl laurate and vinyl stearate, and the corresponding allyl and methallyl esters.

Examples of α-olefins having 2 to 20 carbon atoms are ethylene, propylene, 1-butene, isobutene, 1-pentene, 1 -hexene, diisobutene and the like.

Among the monomers B′, preference is given to the esters of monoethylenically unsaturated C₃-C₆-monocarboxylic acids, especially the esters of acrylic acid or of methacrylic acid, with C₁-C₂₀-alkanols, C₅-C₈-cycloalkanols, phenyl-C₁-C₄-alkanols or phenoxy-C₁-C₄-alkanols, diesters of monoethylenically unsaturated C₄-C₆-dicarboxylic acids with C₁-C₂₀-alkanols, C₅-C₈-cycloalkanols, phenyl-C₁-C₄-alkanols or phenoxy-C₁-C₄-alkanols, and vinylaromatic hydrocarbons, especially styrene.

Among the monomers B′, particular preference is given to the esters of monoethylenically unsaturated C₃-C₆-monocarboxylic acids, especially the esters of acrylic acid or of methacrylic acid, with C₁-C₂₀-alkanols. Among the monomers B′, very particular preference is given to the esters of acrylic acid with C₁-C₁₀-alkanols (=C₁-C₁₀-alkyl acrylates), and the esters of methacrylic acid with C₁-C₁₀-alkanols (=C₁-C₁₀-alkyl methacrylates).

In a particularly preferred embodiment of the invention, the monomers B′ are selected from C₁-C₄-alkyl methacrylates, especially methyl methacrylate, and C₁-C₄-alkyl acrylates, especially ethyl acrylate, butyl acrylate and mixtures of C₁-C₄-alkyl methacrylates with C₁-C₄-alkyl acrylates.

In addition to the aforementioned monomers B′, the monomers B may also comprise one or more nonionic monoethylenically unsaturated monomers B″ different than the monomers B′. These include especially:

monoethylenically unsaturated monomers which have an ethylenically unsaturated double bond and one or two poly-C₂-C₄-alkylene ether groups (monomers B″.1);

the amides of the aforementioned monoethylenically unsaturated C₃-C₈-monocarboxylic acids, especially acrylamide and methacrylamide (monomers B″.2);

hydroxyalkyl esters of the aforementioned monoethylenically unsaturated C₃-C₈-monocarboxylic acids, e.g. hydroxyethyl acrylate, hydroxyethyl methacrylate, 2- and 3-hydroxypropyl acrylate, 2- and 3-hydroxypropyl methacrylate (monomers B″.3); and

N-vinylamides of aliphatic C₁-C₁₀-carboxylic acids, and N-vinyllactams such as N-vinylformamide, N-vinylacetamide, N-vinylpyrrolidone and N-vinylcaprolactam.

Among the monomers B″.1, preference is given to those in which the poly-C₂-C₄-alkylene ether groups are formed to an extent of at least 70% by weight, based on the poly-C₂-C₄-alkylene ether groups, from repeat units of the formula CH₂CH₂O. The remaining up to 30% by weight comprises end groups such as C₁-C₃₀-alkyl, C₅-C₁₀-cycloalkyl, phenylalkyl or phenoxyalkyl, and/or C₃-C₄-alkyleneoxy repeat units such as 1,2-propyleneoxy, 1,2-butyleneoxy or 1-methyl-1,2-ethyleneoxy groups.

Among the monomers B″.1, preference is further given to those in which the poly-C₂-C₄-alkylene ether groups have at least 5, especially at least 10, for example 5 to 200 or especially 10 to 100, C₂-C₄-alkylene oxide repeat units.

Preferred monoethylenically unsaturated monomers which have an ethylenically unsaturated double bond and one or two poly-C₂-C₄-alkylene ether groups (monomers B″.1) are those of the formulae I and II

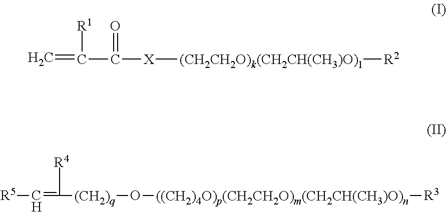

in which the sequence of the repeat units CH₂CH₂O and CH₂CH(CH₃)O is as desired,
k and m are each independently integers from 5 to 100, especially 10 to 80 (numerical average),
l and n are each independently integers from 0 to 100, especially 0 to 30 (numerical average), where the sum of k and l and the sum of m and n are each within the range from 5 to 200, particularly within the range from 10 to 100 and especially within the range from 10 to 60 (numerical average),
is 0 or 1;
q is 0 or 1;
R¹ is hydrogen or C₁-C₄-alkyl, preferably hydrogen or methyl,
R² is C₁-C₃₀-alkyl or C₃-C₃₀-alkenyl,
R³ is C₁-C₃₀-alkyl or C₃-C₃₀-alkenyl,
R⁴ is hydrogen or C₁-C₄-alkyl, preferably hydrogen or methyl,
R⁵ is hydrogen or methyl,
X is O or a group of the formula NR⁶ in which R⁶ is H, C₁-C₆-alkyl, C₃-C₆-alkenyl, C₃-C₆-cycloalkyl, phenyl or benzyl, and is especially hydrogen. In particular, X is oxygen.

In a particularly preferred embodiment of the monomers of the formula II, q is 1, R⁴ is hydrogen and R⁵ is hydrogen.

In a likewise particularly preferred embodiment of the monomers of the formula II, q is 0, R⁴ is hydrogen and R⁵ is hydrogen.

Since the monomers of the formulae I and II are what are known as macromers, i.e. polymerizable oligomers, these monomers have a molecular weight distribution which results from the different chain lengths of the poly-C₂-C₃-alkylene oxide groups in these monomers. Therefore, the numerical values reported for the variables k, l, m and n should be understood as average values, i.e. as the numerical average of the number of repeat units.

Examples of the monomers of the formula I are the esters of acrylic acid with polyethylene glycol mono-C₁-C₃₀-alkyl ethers, especially the esters of acrylic acid with polyethylene glycol monomethyl ethers, with polyethylene glycol monolauryl ethers or with polyethylene glycol monostearyl ethers, esters of methacrylic acid with polyethylene glycol mono-C₁-C₃₀-alkyl ethers, especially the esters of methacrylic acid with polyethylene glycol monomethyl ethers, with polyethylene glycol monolauryl ethers or with polyethylene glycol monostearyl ethers, where the polyethylene glycol groups in the aforementioned esters of acrylic acid and of methacrylic acid with polyethylene glycol mono-C₁-C₃₀-alkyl ethers have preferably 5 to 200, particularly 10 to 100 and especially 10 to 60 repeat units (numerical average).

Examples of the monomers of the formula II are the vinyl ethers of polyethylene glycol mono-C₁-C₃₀-alkyl ethers and the allyl ethers of polyethylene glycol mono-C₁-C₃₀-alkyl ethers, where the polyethylene glycol groups in the aforementioned vinyl and allyl ethers of polyethylene glycol mono-C₁-C₃₀-alkyl ethers have an average of preferably 5 to 100, especially 10 to 80, repeat units (numerical average).

Preferred monomers B″ are the monomers B″.1, B″.2 and B″.3.

If present, the monomers B″ are especially selected from at least one monomer B″.1, especially the monomers of the formulae I and II, and mixtures of at least one monomer B″.1, especially of at least one of the monomers of the formulae I and II, with one or more of the monomers B″.2 and/or B″.3.

In a preferred embodiment of the invention, the monomers B comprise a mixture of at least one monomer B′ and at least one monomer B″.

In a specific embodiment of the invention, the monomers B comprise a mixture of at least one monomer B′ and at least one monomer B″, said monomers B″ being selected from the monomers B″.1, especially the monomers of the formulae I and II, and mixtures of at least one monomer B″.1, especially of at least one of the monomers of the formulae I and II, with one or more of the monomers B″.2 and/or B″.3.

In preferred acrylic polymers, the monomers M which constitute the acrylic polymer comprise
a) 10 to 90% by weight, especially 15 to 50% by weight, based on the total amount of the monomers M which constitute the acrylic polymer, of at least one monomer A, especially of at least one of the monomers A specified as preferred; and
b) 10 to 90% by weight, especially 50 to 85% by weight, based on the total amount of the monomers M which constitute the acrylic polymer, of at least one monomer B, especially of at least one of the monomers B specified as preferred;
   where the total amount of monomers A and B preferably amounts to at least 95% by weight, particularly at least 99% by weight and especially 100% by weight of the monomers M which constitute the polymer.

In particularly preferred acrylic polymers, the monomers M which constitute the acrylic polymer comprise
a) 10 to 90% by weight, especially 15 to 50% by weight, based on the total amount of the monomers M which constitute the acrylic polymer, of at least one monomer A, especially of at least one of the monomers A specified as preferred; and
b) 10 to 90% by weight, especially 50 to 85% by weight, based on the total amount of the monomers M which constitute the acrylic polymer, of a mixture of at least one monomer B′ and at least one monomer B″, especially of a mixture of at least one monomer B′ and at least one monomer B″ where the monomers B″ are selected from the monomers B″.1, especially the monomers of the formulae I and II, and mixtures of at least one monomer B″.1, especially at least one monomer of the formulae I and II, with one or more of the monomers B″.2 and/or B″.3;
   where the total amount of monomers A and B preferably amounts to at least 95% by weight, particularly at least 99% by weight and especially 100% by weight of the monomers M which constitute the polymer.

In addition to the aforementioned monomers A and B, the acrylic polymers may also comprise one or more monoethylenically unsaturated monomers other than the monomers A and B in copolymerized form. These are especially monoethylenically unsaturated monomers which have a sulfo or phospho group and which are also referred to hereinafter as monomers C.

Examples of monomers C suitable in accordance with the invention are:

monoethylenically unsaturated sulfonic acids in which the sulfo group is bonded to an aliphatic hydrocarbon radical, and salts thereof, such as vinylsulfonic acid, allylsulfonic acid, methallylsulfonic acid, 2-acrylamido-2-methylpropanesulfonic acid, 2-methacrylamido-2-methylpropanesulfonic acid, 2-acrylamidoethanesulfonic acid, 2-methacrylamidoethanesulfonic acid, 2-acryloyloxyethanesulfonic acid, 2-meth-acryloyloxyethanesulfonic acid, 3-acryloyloxypropanesulfonic acid and 2-methacryloyloxypropanesulfonic acid and salts thereof,

vinylaromaticsulfonic acids, i.e. monoethylenically unsaturated sulfonic acids in which the sulfo group is bonded to an aromatic hydrocarbon radical, especially to a phenyl ring, and salts thereof, for example styrenesulfonic acids such as 2-, 3- or 4-vinylbenzenesulfonic acid and salts thereof,

monoethylenically unsaturated phosphonic acids in which the phospho group is bonded to an aliphatic hydrocarbon radical, and salts thereof, such as vinylphosphonic acid, 2-acrylamido-2-methylpropanephosponic acid, 2-methacrylamido-2-methylpropanephosphonic acid, 2-acrylamidoethanephosphonic acid, 2-methacrylamidoethanephosphonic acid, 2-acryloyloxyethanephosphonic acid, 2-methacryloyloxyethanephosphonic acid, 3-acryloyloxypropanephosphonic acid and 2-methacryloyloxypropanephosponic acid and salts thereof,

monoethylenically unsaturated phosphoric monoesters, especially the monoesters of phosphoric acid with hydroxy-C₂-C₄-alkyl acrylates and hydroxy-C₂-C₄-alkyl methacrylates, for example 2-acryloyloxyethyl phospate, 2-methacryloyloxyethyl phosphate, 3-acryloyloxypropyl phosphate, 3-methacryloyloxypropyl phosphate, 4-acryloyloxybutyl phosphate and 4-methacryloyloxybutyl phosphate, and salts thereof.

When the monomers C are present in the salt form thereof, they have a corresponding cation as a counterion. Examples of suitable cations are alkali metal cations such as Na⁺ or K⁺, alkaline earth metal ions such as Ca²⁺ and Mg²⁺, and also ammonium ions such as NH₄⁺, tetraalkylammonium cations such as tetramethylammonium, tetraethylammonium and tetrabutylammonium, and also protonated primary, secondary and tertiary amines, especially those which bear 1, 2 or 3 radicals selected from C₁-C₂₀-alkyl groups and hydroxyethyl groups, for example the protonated forms of mono-, di- and tributylamine, propylamine, diisopropylamine, hexylamine, dodecylamine, oleylamine, stearylamine, ethoxylated oleylamine, ethoxylated stearylamine, ethanolamine, diethanolamine, triethanolamine, or of N,N-dimethylethanolamine. Preference is given to the alkali metal salts.

Among the monomers C, preference is given to the monoethylenically unsaturated sulfonic acids and salts thereof, especially monoethylenically unsaturated sulfonic acids in which the sulfo group is bonded to an aliphatic hydrocarbon radical, and salts thereof, especially the alkali metal salts thereof.

The monomers C will, if present, amount to not more than 40% by weight, especially not more than 20% by weight, based on the total amount of monomers M. More particularly, the total amount of monomers A, B and C is at least 95% by weight, particularly at least 99% by weight and especially 100% by weight, based on the total weight of the monomers M which constitute the polymer.

In preferred acrylic polymers, the monomers M which constitute the acrylic polymer accordingly comprise
a) 10 to 90% by weight, especially 15 to 50% by weight, based on the total amount of the monomers M which constitute the acrylic polymer, of at least one monomer A, especially of at least one of the monomers A specified as preferred, especially acrylic acid or methacrylic acid or a mixture thereof; and
b) 10 to 90% by weight, especially 50 to 85% by weight, based on the total amount of the monomers M which constitute the acrylic polymer, of at least one monomer B, especially of at least one of the monomers B specified as preferred;
c) 0 to 40% by weight, e.g. 0.1 to 40% by weight, especially 0 to 30% by weight, e.g. 0.5 to 30% by weight, based on the total amount of the monomers M which constitute the acrylic polymer, of at least one monomer C, especially of at least one of the monomers C specified as preferred;
   where the total amount of monomers A, B and C preferably amounts to at least 95% by weight, particularly at least 99% by weight and especially 100% by weight of the monomers M which constitute the polymer.

In particularly preferred acrylic polymers, the monomers M which constitute the acrylic polymer comprise
a) 10 to 90% by weight, especially 15 to 50% by weight, based on the total amount of the monomers M which constitute the acrylic polymer, of at least one monomer A, especially of at least one of the monomers A specified as preferred, especially acrylic acid or methacrylic acid or a mixture thereof; and
b) 10 to 90% by weight, especially 50 to 85% by weight, based on the total amount of the monomers M which constitute the acrylic polymer, of a mixture of at least one monomer B′ and at least one monomer B″, especially a mixture of at least one monomer B′ and at least one monomer B″ where the monomers B″ are selected from the monomers B″.1, especially the monomers of the formulae I and II, and mixtures of at least one monomer B″.1, especially of at least one of the monomers of the formulae I or II, with one or more of the monomers B″.2 and/or B″.3;
c) 0 to 40% by weight, e.g. 0.1 to 40% by weight, especially 0 to 30% by weight, e.g. 0.5 to 30% by weight, based on the total amount of the monomers M which constitute the acrylic polymer, of at least one monomer C, especially of at least one of the monomers C specified as preferred;
   where the total amount of monomers A, B and C preferably amounts to at least 95% by weight, particularly at least 99% by weight and especially 100% by weight of the monomers M which constitute the polymer.

In a first preferred embodiment of the invention, the monomers A are selected from acrylic acid and methacrylic acid and mixtures thereof. In this first preferred embodiment, the monomers B generally comprise at least one monomer B′, and optionally one or more monomers B″.

In this first preferred embodiment, the monomers B′ are preferably selected from the esters of monoethylenically unsaturated C₃-C₆-monocarboxylic acids, especially the esters of acrylic acid or of methacrylic acid, with C₁-C₂₀-alkanols. In this first preferred embodiment, the monomers B′ are especially selected from C₁-C₁₀-alkyl acrylates and C₁-C₁₀-alkyl methacrylates and mixtures thereof, especially from ethyl acrylate, n-butyl acrylate and methyl methacrylate, and mixtures thereof.

In this first preferred embodiment, the monomers B comprise, in addition to the monomers B′, preferably at least one monomer B″. In this first preferred embodiment, the monomers B″ are preferably selected from the monomers B″.1, especially the monomers of the formulae I and II, and mixtures of at least one monomer B″.1, especially of at least one monomer of the formulae I and II, with one or more of the monomers B″.2 and/or B″.3.

In particularly preferred acrylic polymers, the monomers M which constitute the acrylic polymer comprise:
a) 10 to 60% by weight, especially 15 to 50% by weight, based on the total amount of the monomers M which constitute the acrylic polymer, of acrylic acid and/or methacrylic acid;
b) 10 to 85% by weight, especially 30 to 80% by weight, based on the total amount of the monomers M which constitute the acrylic polymer, of at least one monomer B′ and
b′) 0.1 to 50% by weight, especially 0.5 to 40% by weight, of at least one monomer B″, where the monomers B″ are preferably selected from the monomers B″.1, especially the monomers of the formulae I and II, and mixtures of at least one monomer B″.1, especially of at least one monomer of the formulae I and II, with one or more of the monomers B″.2 and/or B″.3;
   where the total amount of monomers A, B′ and B″ is preferably at least 95% by weight, particularly at least 99% by weight and especially 100% by weight of the monomers M which constitute the polymer. In this embodiment, the total amount of monomers B′ and B″ is typically in the range from 40 to 90% by weight and especially in the range from 50 to 85% by weight, based on the total amount of the monomers M which constitute the polymer.

Examples of acrylic polymers of this embodiment are the acrylic polymers AP1 to AP11 specified below:
acrylic polymer AP1: copolymer formed from methacrylic acid (24.9% by weight), butyl acrylate (74.6% by weight) and monomer of the formula I (X═O, k=25, l=0, R¹═CH₃, R²═C₁₆/C₁₈-alkyl) (0.5% by weight);
acrylic polymer AP2: copolymer formed from methacrylic acid (30% by weight), butyl acrylate (29.25 by weight), ethyl acrylate (39.25% by weight), 2-hydroxyethyl acrylate (10% by weight) and monomer of the formula I (X═O, k=25, l=0, R¹═CH₃, R²═C₁₆/C₁₈-alkyl) (1.5% by weight);
acrylic polymer AP3: copolymer formed from methacrylic acid (15% by weight), butyl acrylate (41.75% by weight), ethyl acrylate (41.75% by weight) and monomer of the formula I (X═O, k=25, l=0, R¹═CH₃, R²═C₁₆/C₁₈-alkyl) (1.5% by weight);
acrylic polymer AP4: copolymer formed from methacrylic acid (30% by weight), butyl acrylate (35% by weight) and ethyl acrylate (35% by weight);
acrylic polymer AP5: copolymer formed from methacrylic acid (29.9% by weight), butyl acrylate (69.6% by weight) and monomer of the formula I (X═O, k=25, l=0, R¹═CH₃, R²═C₁₆/C₁₈-alkyl) (0.5% by weight);
acrylic polymer AP6: copolymer formed from methacrylic acid (29.5% by weight), butyl acrylate (34.75% by weight), ethyl acrylate (34.75% by weight) and monomer of the formula I (X═O, k=25, l=0, R¹═CH₃, R²═C₁₆/C₁₈-alkyl) (1.0% by weight);
acrylic polymer AP7: copolymer formed from methacrylic acid (37% by weight), ethyl acrylate (40% by weight), methacrylamide (2% by weight) and monomer of the formula I (X═O, k=25, l=0, R¹═CH₃, R²═C₁₆/C₁₈-alkyl) (21% by weight);
acrylic polymer AP8: copolymer formed from acrylic acid (68.7% by weight), methacrylic acid (24.6% by weight) and monomer of the formula II (p=0, q=1, m=25, n=0, R³═CH₃, R⁴═R⁵═H) (6.7% by weight);
acrylic polymer AP9: copolymer formed from acrylic acid (60% by weight), acrylamide (20% by weight) and 2-acrylamidomethylpropanesulfonic acid (20% by weight)—molecular weight (number average) 20 000 daltons;
acrylic polymer AP10: copolymer formed from acrylic acid (60% by weight), acrylamide (20% by weight) and 2-acrylamidomethylpropanesulfonic acid (20% by weight)—molecular weight (number average) 6000 daltons;
acrylic polymer AP11: copolymer formed from acrylic acid (72% by weight), maleic acid (10.3% by weight) and monomer of the formula II (p=1, q=0, m=130, n=0, R³═CH₃, R⁴═R⁵═H) (17.7% by weight)).

In further preferred embodiments of the acrylic polymers used in accordance with the invention, the monomers A are selected from maleic acid and maleic anhydride and mixtures thereof.

In these further preferred embodiments, the monomers B are preferably selected from the aforementioned monomers B′, especially from the esters of acrylic acid with C₁-C₁₀-alkanols, the esters of methacrylic acid with C₁-C₁₀-alkanols, vinylaromatic hydrocarbons, especially styrene, and C₄-C₁₂-olefins, such as especially 1-butene, isobutene, 1-pentene, 1-hexene, 1-octene, diisobutene, 1-decene or triisobutene, and mixtures thereof.

In these further preferred embodiments, the monomers M which constitute the acrylic polymer comprise preferably:
a) 20 to 80% by weight, especially 30 to 70% by weight, based on the total amount of the monomers M which constitute the acrylic polymer, of maleic acid and/or maleic anhydride or a mixture of maleic acid or maleic anhydride with acrylic acid and/or methacrylic acid;
b) 20 to 80% by weight, especially 30 to 70% by weight, based on the total amount of the monomers M which constitute the acrylic polymer, of at least one monomer B′ which is preferably selected from the esters of acrylic acid with C₁-C₁₀-alkanols, the esters of methacrylic acid with C₁-C₁₀-alkanols, vinylaromatic hydrocarbons, especially styrene, and C₄-C₁₂-olefins, such as especially 1-butene, isobutene, 1-pentene, 1-hexene, 1-octene, diisobutene, 1-decene or triisobutene, and mixtures thereof,
   where the total amount of monomers A and B preferably amounts to at least 95% by weight, especially at least 99% by weight and especially 100% by weight of the monomers M which constitute the polymer.

One example of a polymer of this embodiment is Sokalan® CP 9 from BASF SE (also referred to hereinafter as acrylic polymer AP12).

In further preferred embodiments of the invention, the acrylic polymers used in accordance with the invention are graft polymers of ethylenically unsaturated monomers which are obtainable by polymer-analogous esterification of acrylic polymers of the above-defined monomers A, B and optionally C with poly-C₂-C₄-alkylene glycols or with poly-C₂-C₄-alkylene glycol monoethers, for example with poly-C₂-C₄-alkylene glycol mono-C₁-C₃₀-alkyl ethers, especially with polyethylene glycols or with polyethylene glycol monoethers, for example with polyethylene glycol mono-C₁-C₃₀-alkyl ethers, where the poly-C₂-C₄-alkylene glycols or poly-C₂-C₄-alkylene glycol monoethers have preferably 5 to 200, particularly 10 to 100 and especially 10 to 60 repeat units (numerical average).

The polymer-analogous reaction of acrylic polymers of the above-defined monomers A, B and optionally C with poly-C₂-C₄-alkylene glycols or with poly-C₂-C₄-alkylene glycol monoethers forms graft polymers with comb structure which have poly-C₂-C₄-alkylene glycol side chains bonded via ester groups to the polymer backbone formed from the monomers A, B and if appropriate C.

In a specific embodiment of the invention, the acrylic polymers are those graft polymers which are obtainable by polymer-analogous reaction of acrylic polymers with poly-C₂-C₄-alkylene glycols or with poly-C₂-C₄-alkylene glycol monoethers, in which the monomers A are selected from maleic acid and maleic anhydride and mixtures thereof. In these embodiments of the graft polymers, the monomers B are preferably selected from the aforementioned monomers B′, especially from the esters of acrylic acid with C₁-C₁₀-alkanols, the esters of methacrylic acid with C₁-C₁₀-alkanols, vinylaromatic hydrocarbons, especially styrene, and C₄-C₁₂-olefins, such as especially 1-butene, isobutene, 1-pentene, 1-hexene, 1-octene, diisobutene, 1-decene or triisobutene, and mixtures thereof.

In this embodiment, the monomers M which form the acrylic polymer used to prepare the graft polymers comprise preferably:
a) 20 to 80% by weight, especially 30 to 70% by weight, based on the total amount of the monomers M which constitute the acrylic polymer, of maleic acid and/or maleic anhydride;
b) 20 to 80% by weight, especially 30 to 70% by weight, based on the total amount of the monomers M which constitute the acrylic polymer, of at least one monomer B′ which is preferably selected from the esters of acrylic acid with C₁-C₁₀-alkanols, the esters of methacrylic acid with C₁-C₁₀-alkanols, vinylaromatic hydrocarbons, especially styrene, and C₄-C₁₂-olefins, such as especially 1-butene, isobutene, 1-pentene, 1-hexene, 1-octene, diisobutene, 1-decene or triisobutene, and mixtures thereof,
   where the total amount of monomers A and B preferably amounts to at least 95% by weight, especially at least 99% by weight and especially 100% by weight of the monomers M which constitute the polymer.

In the graft polymers, the proportion by weight of structural units which result from the poly-C₂-C₄-alkylene glycols or poly-C₂-C₄-alkylene glycol monoethers is generally 0.1 to 50% by weight, especially 0.5 to 30% by weight, based on the total weight of the graft polymer. Accordingly, the graft polymers are prepared using the poly-C₂-C₄-alkylene glycols or poly-C₂-C₄-alkylene glycol monoethers in an amount of 0.1 to 100 parts by weight, especially of 0.5 to 43 parts by weight, based on 100 parts by weight of the polymer formed from monomers A, B and if appropriate C.

Examples of polymers of these embodiments are the polymers Sokalan® CP42, Sokalan® HP80 and Sokalan® PM70.

In further preferred embodiments of the invention, the acrylic polymers used in accordance with the invention are polymers formed essentially, i.e. to an extent of at least 90% by weight, or exclusively, from units of polymerized monoethylenically unsaturated monomers A. In this context, the monomers A are selected from the aforementioned monoethylenically unsaturated mono- and dicarboxylic acids having 3 to 8 carbon atoms, especially from acrylic acid, methacrylic acid and maleic acid, and the internal anhydrides of monoethylenically unsaturated dicarboxylic acids having 3 to 8 carbon atoms, such as especially maleic anhydride. Among these, a specific embodiment relates to those acrylic polymers which comprise at least one monoethylenically unsaturated monocarboxylic acid having 3 to 8 carbon atoms, especially acrylic acid and/or methacrylic acid and optionally one or more monoethylenically unsaturated dicarboxylic acids having 3 to 8 carbon atoms and/or internal anhydrides thereof, such as maleic acid or maleic anhydride, in copolymerized form as monomers A. Examples of polymers of this type are homopolymers of acrylic acid, homopolymers of methacrylic acid, copolymers of acrylic acid with methacrylic acid, copolymers of acrylic acid with maleic acid or maleic anhydride, and copolymers of methacrylic acid with maleic acid or maleic anhydride.

Examples of polymers of these embodiments are the following acrylic polymers AP13 to AP15:
acrylic polymer AP13: Sokalan® CP 7 from BASF SE;
acrylic polymer AP14: Sokalan® CP 12S from BASF SE;
acrylic polymer AP15: Sokalan® CP 13S from BASF SE.

The acrylic polymers are known or can be prepared by customary methods by free-radical polymerization of the ethylenically unsaturated monomers M. The polymerization can be effected by free-radical polymerization or by controlled free-radical polymerization processes. The polymerization can be performed using one or more initiators, and as a solution polymerization, as an emulsion polymerization, as a suspension polymerization or as a precipitation polymerization, or else in bulk. The polymerization can be performed as a batchwise reaction, or in semicontinuous or continuous mode.

The reaction times are generally in the range between 1 and 12 hours. The temperature range within which the reactions can be performed ranges generally from 20 to 200° C., preferably from 40 to 120° C. The polymerization pressure is of minor importance and may be within the range from standard pressure or slightly reduced pressure, for example >800 mbar, to elevated pressure, for example up to 10 bar, though higher or lower pressures may likewise be employed.

The initiators used for the free-radical polymerization are customary free-radical-forming substances. Preference is given to initiators from the group of the azo compounds, the peroxide compounds and the hydroperoxide compounds. The peroxide compounds include, for example, acetyl peroxide, benzoyl peroxide, lauroyl peroxide, tert-butyl peroxyisobutyrate, caproyl peroxide. In addition to hydrogen peroxide, the hydroperoxides also include organic peroxides such as cumine hydroperoxide, tert-butyl hydroperoxide, tert-amyl hydroperoxide and the like. The azo compounds include, for example, 2-2′-azobisisobutyronitrile, 2,2′-azobis(2-methylbutyronitrile), 2,2′-azobis[2-methyl-N-(2-hydroxyethyl)propionamide], 1,1′-azobis(1-cyclohexanecarbonitrile), 2,2′-azobis(2,4-dimethylvaleronitrile), 2,2′-azobis(N,N′-dimethyleneisobutyroamidine). Particular preference is given to azobisisobutyronitrile (AIBN). The initiator is typically used in an amount of 0.02 to 5% by weight and especially 0.05 to 3% by weight, based on the amount of the monomers M, though it is also possible to use greater amounts, for example up to 30% by weight, for example in the case of hydrogen peroxide. The optimal amount of initiator naturally depends on the initiator system used and can be determined by the person skilled in the art in routine experiments.

Some or all of the initiator can be initially charged in the reaction vessel. Preference is given to adding the majority of the initiator, especially at least 80%, for example 80 to 100%, of the initiator, in the course of polymerization in the polymerization reactor.

It will be appreciated that the molecular weight of the acrylic polymers can be adjusted by addition of regulators in a small amount, for example 0.01 to 5% by weight, based on the polymerizing monomers M. Useful regulators include especially organic thio compounds, for example mercapto alcohols such as mercaptoethanol, mercaptocarboxylic acids such as thioglycolic acid, mercaptopropionic acid, alkyl mercaptans such as dodecyl mercaptan, and also allyl alcohols and aldehydes.

More particularly, the acrylic polymers are prepared by free-radical solution polymerization in an organic solvent or solvent mixture. Examples of organic solvents are alcohols, for example methanol, ethanol, n-propanol and isopropanol, dipolar aprotic solvents, for example N-alkyllactams such as N-methylpyrrolidone (NMP), N-ethylpyrrolidone, and also dimethyl sulfoxide (DMSO), N,N-dialkylamides of aliphatic carboxylic acids, such as N,N-dimethylformamide (DMF), N,N-dimethylacetamide, and also aromatic, aliphatic and cycloaliphatic hydrocarbons which may be halogenated, such as hexane, chlorobenzene, toluene or benzene, and mixtures thereof. Preferred solvents are isopropanol, methanol, toluene, DMF, NMP, DMSO and hexane, particular preference being given to isopropanol. In addition, the homo- and copolymers P can be prepared in a mixture of the above-described solvents and solvent mixtures with water. The water content of these mixtures is preferably less than 50% by volume and especially less than 10% by volume.

Optionally, the actual polymerization may be followed by a postpolymerization, for example by addition of a redox initiator system. The redox initiator systems consist of at least one, usually inorganic, reducing agent and an inorganic or organic oxidizing agent. The oxidation component comprises, for example, the aforementioned peroxide compounds. The reduction component comprises, for example, alkali metal salts of sulfurous acid, for example sodium sulfite, sodium hydrogensulfite, alkali metal salts of disulfurous acid such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems can be used with additional use of soluble metal compounds whose metallic components can occur in different valence states. Customary redox initiator systems are, for example, ascorbic acid/iron(II) sulfate/sodium peroxodisulfate, tert-butyl hydroperoxide/sodium disulfite, tert-butyl hydroperoxide/sodium hydroxy-methanesulfinate. The individual components, for example the reduction component, may also be mixtures, for example a mixture of the sodium salt of hydroxymethanesulfinic acid and sodium disulfite. The acrylic polymer is typically used in amounts of about 0.2 to about 2.5% by weight, more preferably about 0.5 to about 2.0% by weight and especially about 1.00 to about 1.75% by weight. It is also possible to use mixtures of acrylic polymers.

In addition, the inventive compositions may comprise further conventional constituents, such as fluorine-free surface-active components, organic solvents. In addition, the inventive compositions comprise at least one thickener and water. Additional optional components are biocides, preservatives, corrosion inhibitors, colorants, etc., which can be used in customary amounts. Such optional components are known to those skilled in the art. Preferred organic solvents which may be used in accordance with the invention are glycols, especially preferably 1,2-propylene glycol and/or ethylene glycol, and also mixtures of solvents. Such organic solvents are used in the inventive composition typically in an amount of 5 to 20% by weight, more preferably 10 to 20% by weight and especially 12 to 15% by weight. Variation of this component of the composition enables the frost resistance of the composition to be adjusted, as may be required, for example, for foam concentrates that are stored in cold climates.

Suitable additional conventional additives, as mentioned above, are especially surfactants.

Surfactants for use in accordance with the invention may be selected from anionic surfactants, nonionic surfactants, amphoteric surfactants and cationic surfactants, and mixtures thereof. The term “surfactants” refers to compounds which are also described as wetting agents or surface-active agents. The inventive composition preferably comprises a mixture of anionic and nonionic surfactants. The composition of the present application is preferably free of cationic surfactants. The surfactants are preferably present in the inventive compositions in a total amount (based on the total amount of surfactants in relation to the total weight of the composition) of 10 to 25% by weight, more preferably 12 to 22% by weight and especially 15 to 20% by weight. Preference is given, as mentioned above, to mixtures of at least one anionic surfactant, for example 1, 2 or 3 anionic surfactants, and at least one nonionic surfactant, for example 1, 2 or 3 nonionic surfactants. In these mixtures, the ratio of anionic to nonionic surfactants (weight ratio) may vary over a wide range. Especially suitable are mixtures of at least one anionic surfactant with at least one nonionic surfactant, in which the weight ratio of anionic to nonionic surfactant is in the range from 10:1 to 1:10, especially 5:1 to 1:5, more preferably 2:1 to 1:2. Use of the surfactant enables good foam generation for fire applications with minimal emulsifying effects.

Suitable surfactants, especially anionic and nonionic surfactants, are well known to those skilled in the art and can be purchased commercially. Suitable anionic surfactants are especially C₈-C₂₀-alkyl sulfates, i.e. sulfuric monoesters of C₈-C₂₀-alkanols, e.g. octyl sulfate, 2-ethylhexyl sulfate, decyl sulfate, lauryl sulfate, myristyl sulfate, cetyl sulfate and stearyl sulfate, and salts thereof, especially the ammonium, substituted ammonium and alkali metal salts thereof, and also C₈-C₂₀-alkyl ether sulfates, i.e. sulfuric monoesters of C₂-C₄-alkoxylated C₈-C₂₀-alkanols, especially sulfuric monoesters of ethoxylated C₈-C₂₀-alkanols and salts thereof, especially the ammonium, substituted ammonium and alkali metal salts thereof, where the degree of alkoxylation (or degree of ethoxylation), i.e. the number of C₂-C₄-alkylene oxide repeat units (or ethylene oxide repeat units) is generally in the range from 1 to 100 and especially in the range from 2 to 20. Examples of C₈-C₂₀-alkyl ether sulfates are the sulfuric monoesters of ethoxylated n-octanol, of ethoxylated 2-ethylhexanol, of ethoxylated decanol, of ethoxylated lauryl alcohol, of ethoxylated myristyl alcohol, of ethoxylated cetyl alcohol and of ethoxylated stearyl alcohol. The inventive composition preferably comprises a mixture of at least 2, for example 2 or 3, anionic surfactants with different carbon numbers.

Substituted ammonium is understood to mean ammonium ions which bear 1, 2, 3 or 4, especially 1, 2 or 3, substituents other than hydrogen on their nitrogen atom of the ammonium ion, where the substituents are preferably selected from C₁-C₄-alkyl such as methyl, ethyl, n-propyl, isopropyl, n-butyl, 2-butyl or tert-butyl, C₂-C₄-hydroxyalkyl such as 2-hydroxyethyl, 2-hydroxypropyl or 3-hydroxypropyl, and hydroxy-C₂-C₄-alkyloxy-C₂-C₄-alkyl such as 2-(2-hydroxyethoxy)ethyl. Examples of substituted ammonium are especially mono-, di-, tri- and tetramethylammonium, mono-, di-, tri- and tetraethylammonium, dimethylpropylammonium, mono- and di-n-propylammonium, mono- and diisopropylammonium, 2-hydroxyethylammonium, bis(2-hydroxyethylammonium), tris(2-hydroxyethyl)ammonium, 2-(2-hydroxyethoxy)ethylammonium and the like.

Suitable anionic surfactants are especially surfactants based on the sodium salt of octyl sulfate and triethanolammonium salts of fatty alcohol sulfates, preferably a mixture of lauryl sulfate and myristyl sulfate, components which are commercially available under the names Texapon 842 and Hansanol AS 240T. Further suitable commerically available products are Sulfethal 40/69 and Sabotol C8.

Examples of nonionic surfactants are alkyl polyglucosides, especially alkyl polyglucosides having 6 to 14 carbon atoms in the alkyl radical, for example the commercial product Glucopon 215 UP from Cognis, or the C₉/C₁₁-alkyl polyglucoside sold under the trade name APG325n from Cognis. The chemical nature of these surfactants for use in accordance with the invention is not critical, but preference is given to using materials which are based on renewable raw materials and/or are biodegradable.

In addition, the inventive composition comprises at least one thickener, particularly at least one thickener based on polysaccharides and especially at least one xanthan gum thickener. Such thickeners are used typically in an amount of 0.2 to 7% by weight, more preferably 1 to 6% by weight and especially 3 to 5% by weight.

The advantages of the present invention come to bear especially in the case of those thickeners selected from polysaccharide thickeners. These include modified celluloses and modified starches, especially cellulose ethers such as methylcellulose, carboxymethylcellulose, hydroxyethylcellulose, hydroxypropylcellulose, methylhydroxypropylcellulose, methylhydroxyethyl-cellulose, natural polysaccharides such as xanthan, carrageenan, especially κ-carrageenan, λ-carrageenan or τ-carrageenan, alginates, guaran and agar, and also modified xanthan such as succinylglycan, or modified carrageenan.

Preference is given to polysaccharide thickeners, especially those having anionic groups, such as carboxymethylcellulose, xanthan, modified xanthan, carrageenan, modified carrageenan and alginates. Particularly preferred thickeners are xanthan and modified xanthan, for example the xanthan products sold under the trade names Keltrol® and Kelzan® from Kelco, for example the Keltrol® products Keltrol® CG, Keltrol® CG-F, Keltrol® CG-T, Keltrol® CG-BT, Keltrol® CG-SFT or Keltrol® RT, and the Kelzan® products Kelzan® T, Kelzan® ST, Kelzan® HP-T and Kelzan® ASX-T and Rhodopol®, e.g. the Rhodopol® products 23, 50MC, G, T and TG from Rhodia. Suitable examples are especially xanthan-based thickeners which are commercially available under the Keltrol name.

In the inventive composition, preference is given to using the essential fatty alcohol, thickener and acrylic polymer components in such an amount as to give a weight ratio of fatty alcohol:acrylic polymer in the range from 0.5:1 to 10:1, frequently in the range from 1:1 to 10:1, preferably in the range from 0.5:1 to 5:1 or 1:1 to 5:1, more preferably in the range from 0.5:1 to 2:1 or 1:1 to 2:1, i.e. the inventive composition preferably comprises a proportion by weight of fatty alcohol which is at least half as large or larger or at least equally large, compared to the proportion by weight of acrylic polymer. It is likewise preferred when the amount of thickener (likewise based on parts by weight) is greater than the proportion of acrylic polymer, and it is especially preferred when the proportion by weight of thickener is also greater than the proportion by weight of fatty alcohol.

In addition, the inventive composition also comprises a relatively large amount of water, preferably at least 40% by weight, more preferably at least 50% by weight and in embodiments more than 54% by weight, for example up to 65% by weight or up to 62% by weight. In a particularly preferred embodiment, the inventive composition consists of anionic and nonionic surfactants, fatty alcohol, thickener, organic solvent and acrylic polymer in the amounts specified above, together with the amount of water described above.

In addition, the inventive compositions may also comprise customary constituents as may typically be present in the prior art compositions for production of foam extinguishants. These include agents for adjusting the pH, such as acids, bases or buffers, and also biocides for preventing infestation with microorganisms.

The inventive composition typically does not comprise any polyoxyalkylenediamine substituted at both ends by an aminoalkyl group, and the inventive composition preferably likewise comprises neither caramelized or carbonized saccharides, as absolutely required, for example, in WO 03/049813 A1, nor coordinating salts, as considered to be essential in WO 2004/112907 A2.

By virtue of the inventive composition, it is possible to use a comparatively high amount of thickeners. It is surprisingly nevertheless possible to ensure that the preconcentrate of the foam extinguishant (i.e. the composition before the mixing and deployment in the event of fire, for provision of a foam extinguishant) also remains fluid enough that conventional metering devices can be used to deploy foam extinguishants. If the amounts of thickener used in accordance with the invention were used in the prior art compositions, the viscosity at 20° C. and a shear rate of 100/min would already be at values which have a gel-like consistency, such that conventional metering devices can no longer be used.

Overall, the inventive composition can provide a fluorine-free foam extinguishant which meets high demands. At the same time, the starting viscosity of the inventive composition is low enough to enable mixing and foaming using conventional mixing and foaming devices, which, in the event of use (fire) reproducibly enable an extinguishing foam with maximum extinguishing power, more particularly also in the event of liquid fires.

The inventive compositions are fluorine-free, especially halogen-free. The term “halogen-free” or “fluorine-free” in the context of the present invention means that no organohalogen substances, more particularly no organofluorine substances, are incorporated into the inventive compositions in the course of production thereof. The term “halogen-free” or “fluorine-free” in the context of the present invention means more particularly that the content of organohalogen substances, especially of organofluorine substances, complies with the limits for organic fluorine or halogen required for extinguishant concentrates. More particularly, the content of organofluorine substances in the inventive compositions is below 10 ppm and especially below 5 ppm, based on the total weight of the composition, or below 20 ppm and especially below 10 ppm based on the solids content of the composition, in each case calculated as fluorine. The skilled artisan will recognize that a composition that is halogen-free might still contain trace amounts of a halogen-containing compound by virtue of its presence as an impurity. Such an impurity might be present, for example, in the commercially available starting materials used to make the component, in the water used to make the composition or used to prepare the foam, or might have been introduced as a by-product from reaction with commercial reagents. The compositions as described herein are essentially free of components that contain perfluoro moieties, such as fluorosurfactants and the like.

As already explained above, the inventive compositions can be diluted with water without any problem and foamed in a manner known per se to give a foam extinguishant. Accordingly, the invention also relates to the use of the inventive composition for production of a foam extinguishant. For this purpose, the inventive compositions, which can also be viewed as extinguishant concentrates, are added in a suitable amount to the extinguishing water, i.e. diluted with water, and foamed by means of suitable foaming techniques to give a foam extinguishant. The amounts of inventive composition which is added to the extinguishing water are guided in a manner known per se by the foam to be produced and are typically in the range from 1 to 10% by weight, especially in the range from 2 to 8% by weight, based on the extinguishing water, for example 3% by weight or 6% by weight.

The foam extinguishants thus obtainable reliably meet high demands on the extinguishment performance, as laid down in EN 1568:2008, especially parts 3 and 4, these high extinguishment performances being categorizable in class 1, which comprises burnback resistance classes A to C. The inventive compositions attain extinguishment performance classes of category 1A or 1B, as defined above, especially for extinguishment performance classes according to EN 1568:2008 part 3 and 1A to 1C according to part 4.

The present invention also relates to the use of a composition as described here and in the claims for fighting fires, especially for fighting liquid fires, specifically both liquid fires of nonpolar organic liquids and liquid fires of polar organic liquids. The inventive compositions are of course also suitable for fighting solids fires. The inventive compositions can be used both for extinguishment of fires and for protection of articles from ignition.

The compositions have been described above particularly in connection with the provision of foam extinguishants. However, the compositions can also be used in other fields of application, especially as a foam barrier (for example against escaped liquid materials, such as solvents, chemicals, etc.), as a foam detergent, or else as an additive in boreholes, for example for a barrier effect.

The compositions as described herein are useful for preparing foams that can be used for fighting fires in a wide variety of situations, and on a large or small scale, for example forest fires, building fires and the like. The foams are particularly useful for fighting fires caused or fueled by highly flammable industrial liquids, such as petrochemicals, organic solvents, and intermediates or monomers used in polymer synthesis. In particular the foams may be effectively used to suppress and/or extinguish fires where the burning material contains volatile fuels and/or solvents. Examples include, but are not limited to: hydrocarbons and hydrocarbon mixtures such as gasoline, pentane, hexane and the like; alcohols, such as methanol, ethanol, isopropanol and the like; ketones such as acetone, methyl ethyl ketone and the like; ethers, including cyclic ethers, such as diethyl ether, methyl t-butyl ether, ethyl t-butyl ether, tetrahydrofuran and the like; esters, such as ethyl acetate, propyl acetate, ethyl propionate and the like; oxiranes, such as propylene oxide, butylene oxide and the like; and mixtures of one or more of these materials. The skilled artisan will appreciate that this list is merely illustrative and non-limiting.

Another aspect of the concentrates that is useful in fighting fires in an industrial setting is that the foams not only have a particularly long drain time, thereby providing prolonged vapor-suppression properties, but that the concentrates used to prepare the foam are surprisingly stable at pH values that are moderately acidic, e.g. about pH 2 and above, about pH 3 and above, about pH 4 and above, about pH 5 and above, or about pH 6 and above. The addition of weak organic acids, such as citric acid and the like, permits the preparation of concentrates of reduced pH that, in turn, produce foams of reduced pH.

Such foams have advantageous properties in fighting fires that are fueled by flammable solvents or liquids that are miscible with water but that hydrolyze or decompose only slowly at neutral pH. Lowering the pH can, at least for some compounds, cause a much more rapid, acid-catalyzed hydrolysis or decomposition that produces benign, or at least less flammable, products. Thus, for example, propylene oxide is miscible with water, but hydrolyzes only slowly at neutral pH while retaining a relatively high vapor pressure over the water/propylene oxide mixture. Lowering the pH dramatically increases hydrolysis of the propylene oxide to alcohol by-products that also are miscible with the water and that are non-flammable in aqueous solution, thereby reducing the ongoing fire risk.

The present invention further relates to a method for fighting fires, especially for fighting fires of organic liquids or for fighting solids fires. For this purpose, the inventive composition will be diluted with water, or added to the extinguishing water in the desired amount, for example in the amounts specified above, and the diluted composition thus obtained will be foamed by means of suitable equipment to give a foam extinguishant. In general, the equipment is that known for use for production of extinguishing foams. Such equipment generally comprises a means of generating the foam, for example foam nozzles for heavy or medium foam or foam generators, the principle of which is generally based on mixing of the aqueous diluted inventive composition with air in a suitable manner to give a foam. In the case of foam nozzles, the aqueous diluted inventive composition is fed through a nozzle at high speed into a tube with orifices for ingress of air, which are arranged close to the nozzle, as a result of which air is sucked in and forms a foam. The extinguishing foam thus generated is applied in a manner known per se to the seat of fire or to sites which are to be protected from a fire. The diluted composition is generally obtained in situ, i.e. the inventive composition is fed continuously to the extinguishing water during the extinguishment operation, generally by means of so-called inductors, for example inline inductors, injector inductors, pump inductors or bladder tank inductors, which supply the amount of inventive composition needed for foam production to the extinguishing water stream or to a portion of the extinguishing water stream. With regard to the techniques of foaming and of application of extinguishing foams, reference is made to the relevant specialist literature; see, for example, Klingsohr, Kurt: Die Roten Hefte (1)—Verbrennen and Löschen, Kohlhammer-Verlag, p. 80; Karl Ebert, Handbuch Feuerwehramaturen, Max Widenmann K G; Feuerwehr-Magazin Sonderheft 2006 “Brandbekämpfung mit Schaum”, page 26ff; Feuerwehr-Magazin Sonderheft 2010 “Brandbekämpfung mit Schaum (aktualisierte Auflage)”, page 58ff.

The foams obtainable from the inventive compositions are also suitable for covering volatile organic substances, for example organic liquids, e.g. volatile organic chemicals, which have been released into the environment in liquid form in the event of an accident or in some other way. The covering of such substances is possible in a simple manner, by applying a foam over an area, i.e. as a foam blanket, onto the surface of the organic volatile substances, for example an escaped liquid, and in this way covering it. In this way, it is possible to effectively prevent vaporization of the organic substance with the inventive compositions.

It also been found that, surprisingly, the inventive compositions can be used in the development and extraction of fossil fuels from natural underground deposits, i.e. in the development and extraction of mineral oil and natural gas deposits. The inventive compositions can be used in liquid form, for example in the form of an aqueous fracturing fluid to which an inventive composition has been added, or as a foam. Accordingly, the invention also relates to the use of an inventive composition in liquid form or in the form of a foam in the extraction of fossil fuels from natural underground deposits.

Owing to their properties, the inventive compositions can be added to so-called fracturing or stimulation fluids. Fracturing or stimulation fluids are aqueous liquids which are used in the tertiary extraction of fossil fuels (so-called polymer flooding or surfactant flooding). This involves injecting aqueous, surfactant-containing liquids, optionally as foams, under pressure via boreholes into the underground formations in which the deposits are present, which leads there to fracturing of the rock in the rock formations bearing the fossil fuels, and causes release of the fuels from the rock particles and enrichment of the fuels in the fracturing or stimulation fluid (for example by emulsification).

Accordingly, the invention also relates to a method for extracting fossil fuels from natural underground deposits present in underground formations, comprising the introduction of an aqueous liquid or of a foam, which comprise an inventive composition, into the underground formations in which the underground deposits are present.

Such methods are known in principle, for example from U.S. Pat. No. 3,937,283, U.S. Pat. No. 5,069,283, U.S. Pat. No. 6,194,356, EP 1298280, EP 1634938, WO 02/11874 and WO 03/056130. For this purpose, the inventive compositions are generally diluted with water and injected by means of a gas, for example nitrogen or CO₂, through boreholes into the underground formations bearing fossil fuels, wherein they foam and display their fracturing action, and cause release of the fossil fuels from the rock materials.

The examples which follow illustrate the present invention.

The following polymers AP1 to AP15 were examined. The preparation of the polymers AP1 to AP11 can be performed in analogy to the method specified in example 1 of WO 2009/062944.
acrylic polymer AP1: copolymer formed from methacrylic acid (24.9% by weight), butyl acrylate (74.6% by weight) and monomer of the formula I (X═O, k=25, l=0, R¹═CH₃, R²═C₁₆/C₁₈-alkyl) (0.5% by weight);
acrylic polymer AP2: copolymer formed from methacrylic acid (20% by weight), butyl acrylate (29.25 by weight), ethyl acrylate (39.25% by weight), 2-hydroxyethyl acrylate (10% by weight) and monomer of the formula I (X═O, k=25, l=0, R¹═CH₃, R²═C₁₆/C₁₈-alkyl) (1.5% by weight);
acrylic polymer AP3: copolymer formed from methacrylic acid (15% by weight), butyl acrylate (41.75% by weight), ethyl acrylate (41.75% by weight) and monomer of the formula I (X═O, k=25, l=0, R¹═CH₃, R²═C₁₆/C₁₈-alkyl) (1.5% by weight);
acrylic polymer AP4: copolymer formed from methacrylic acid (30% by weight), butyl acrylate (35% by weight) and ethyl acrylate (35% by weight);
acrylic polymer AP5: copolymer formed from methacrylic acid (29.9% by weight), butyl acrylate (69.6% by weight) and monomer of the formula I (X═O, k=25, l=0, R¹═CH₃, R²═C₁₆/C₁₈-alkyl) (0.5% by weight);
acrylic polymer AP6: copolymer formed from methacrylic acid (29.5% by weight), butyl acrylate (34.75% by weight), ethyl acrylate (34.75% by weight) and monomer of the formula I (X═O, k=25, l=0, R¹═CH₃, R²═C₁₆/C₁₈-alkyl) (1.0% by weight);
acrylic polymer AP7: copolymer formed from methacrylic acid (37% by weight), ethyl acrylate (40% by weight), methacrylamide (2% by weight) and monomer of the formula I (X═O, k=25, l=0, R¹═CH₃, R²═C₁₆/C₁₈-alkyl) (21% by weight);
acrylic polymer AP8: copolymer formed from acrylic acid (68.7% by weight), methacrylic acid (24.6% by weight) and monomer of the formula II (p=0, q=1, m=25, n=0, R³═CH₃, R⁴═R⁵═H) (6.7% by weight);
acrylic polymer AP9: copolymer formed from acrylic acid (60% by weight), acrylamide (20% by weight) and 2-acrylamidomethylpropanesulfonic acid (20% by weight)—molecular weight (number average) 20 000 daltons;
acrylic polymer AP10: copolymer formed from acrylic acid (60% by weight), acrylamide (20% by weight) and 2-acrylamidomethylpropanesulfonic acid (20% by weight)—molecular weight (number average) 6000 daltons;
acrylic polymer AP11: copolymer formed from acrylic acid (72% by weight), maleic acid (10.3% by weight) and monomer of the formula II (p=1, q=0, m=130, n=0, R³═CH₃, R⁴═R⁵═H) (17.7% by weight));
acrylic polymer AP12: Sokalan® CP 9 from BASF SE;
acrylic polymer AP13: Sokalan® CP 7 from BASF SE;
acrylic polymer AP14: Sokalan® CP 12S from BASF SE;
acrylic polymer AP15: Sokalan® CP 13S from BASF SE.

The inventive compositions listed in table 1 below (amounts stated in % w/w) were formulated in a customary manner and then evaluated with regard to their properties. They exhibit viscosities in the range of 290-350 mPa·s at 20° C. In addition, three modified comparative compositions were produced, which are based on formulation 1. The fatty alcohol component was omitted in the first comparative example, while the acrylic polymer was omitted in the second comparative example, and both components were omitted in the third comparative example. Such compositions exhibit an undesired rise in viscosity to values of about 700 mPa·s for comparative examples 1 and 2, and more than 2000 mPa·s for comparative example 3. Such compositions are no longer suitable as foam extinguishants since the viscosity is too high for the prodution of a foam extinguishant with customary metering devices.

In tables 1 and 2 below, all amounts stated should be understood in % by weight of active constituent.

TABLE 1

| | Formula- | Formula- | Formula- |
|---|---|---|---|
| Chemical name | tion 1 | tion 2 | tion 3 |
| Octylsulfate, sodium | 3.60 | 3.60 | 3.60 |
| salt | | | |
| Lauryl/myristyl alcohol | 2.00 | 2.00 | 1.00 |
| Octanol | | | 1.00 |
| Alkyl polyglucoside | 10.50 | 10.50 | 10.50 |
| Lauryl-/myristylsulfate, | 5.20 | 5.20 | 5.20 |
| TEA salt | | | |
| Acrylic polymer | 1.50 | 1.50 | 1.50 |
| 1,2-Propylene glycol | 14.00 | 14.00 | 14.00 |
| Polysaccharide | 4.00 | 3.00 | 4.00 |
| Ethylene glycol | | | 5.00 |
| Water | 59.20 | 60.20 | 54.20 |

Inventive compositions were formulated in an analogous manner using polymers AP2 to AP15. The particular overall composition is reported in table 2:

TABLE 2

| Chemical name | 4 | 5 | 6 | 7 | 8 | 9 | 10 |
|---|---|---|---|---|---|---|---|
| Type | 2:3:1 | 3:3:1 | 2:3:0.5 | 2:4:0.5 | 3:2:1 | 3:1:0.5 | 4:3:2 |
| Octylsulfate, sodium salt¹⁾ | 3.60 | 3.60 | 3.60 | 3.60 | 3.60 | 3.60 | 3.60 |
| Lauryl/myristyl alcohol | 1.00 | 1.00 | 0.50 | 0.5 | 1.00 | 0.5 | 2.00 |
| Alkyl polyglucoside²⁾ | 9.75 | 9.75 | 9.75 | 9.75 | 9.75 | 9.75 | 9.75 |
| Lauryl-/myristylsulfate, TEA salt³⁾ | 5.20 | 5.20 | 5.20 | 5.20 | 5.20 | 5.20 | 5.20 |
| Acrylic polymer | 0.90 | 0.90 | 0.90 | 1.20 | 0.60 | 0.30 | 0.90 |
| 1,2-Propylene glycol | 14.00 | 14.00 | 14.00 | 14.00 | 14.00 | 14.00 | 14.00 |
| Polysaccharide⁴⁾ | 2.00 | 3.00 | 2.00 | 2.00 | 3.00 | 3.00 | 4.00 |
| Water | 63.55 | 62.55 | 64.05 | 63.75 | 62.85 | 63.65 | 60.55 |

¹⁾Octylsulfate, sodium salt, 40% by weight solution: Texapon 842 (Cognis)
²⁾62.5% by weight solution: Glucopon 215 UP (Cognis)
³⁾Lauryl/myristylsulfate, triethanolammonium salt, 40% by weight solution: Hansanol AS 240T
⁴⁾Xanthan gum (Keltrol BT)

Acrylic polymers AP5, AP9, AP11 and AP13 were formulated according to example 4, formulation type 2:3:1.

Acrylic polymers AP8 and AP10 were formulated according to example 5, formulation type 3:3:1.

Acrylic polymers AP5, AP6 and AP15 were formulated according to example 6, formulation type 2:3:0.5.

Acrylic polymers AP4, AP1, AP9, AP11, AP12 and AP14 were formulated according to example 7, formulation type 2:4:0.5.

Acrylic polymers AP2 and AP3 were formulated according to example 8, formulation type 3:2:1.

Acrylic polymers AP1, AP2, AP3, AP4, AP5, AP6 and AP7 were formulated according to example 9, formulation type 3:1:0.5. Acrylic polymer AP7 was formulated according to example 10, formulation type 4:3:2.

### Determination of Flowability:

The inventive compositions were examined with regard to their flowability. For this purpose, 30 g of each composition were introduced into 50 ml snap-lid bottles (diameter 30 mm, height approx. 8 cm), closed with a lid and left at room temperature. Then the bottles were inverted, and a stop watch was used to determine the time for the composition to reach the lid. A composition is considered to be flowable if it has reached the lid within fewer than 3 sec. All compositions of acrylic polymers AP2 to AP15 specified in table 2 were flowable.

### Determination of the Foaming Index FI (Expansion Ratio) and the Water Halflife WHL (50% Drainage Time)

3 g of an inventive formulation were diluted to 100 ml with deionized water (test series 1) or with a 0.3% by weight NaCl solution in 21° dH water (test series 2). The diluted composition thus obtained was introduced into an inert gas-operated foaming apparatus comprising a pressure-resistant reservoir vessel, an inert gas supply and a manual valve equipped with a slot nozzle for discharge of the foam, and expelled with a pressure of 4 bar through a slot nozzle (slot width 0.5 mm) into a 1000 ml measuring cylinder to determine the amount of foam. The foaming index FI indicates how many milliliters of foam are obtained per ml of diluted composition. The results are compiled in table 3.

To determine the water halflife, the time needed for half of the liquid present in the foam to flow out of the foam was determined. For this purpose, the time was measured from the ending of the foaming operation to the time at which the amount of liquid formed in the measuring cylinder was 50 ml. The results are compiled in table 3.

TABLE 3

| Acrylic | Formulation | Test series 1 | | Test series 2 | |
|---|---|---|---|---|---|
| polymer | type | FI | WHL (min) | FI | WHL (min) |
| AP1 | 3:1:0.5 | 6.1 | 35 | 4.9 | 23 |
| AP2 | 3:1:0.5 | 4.9 | 31 | 5.3 | 31 |
| AP3 | 3:1:0.5 | 6.4 | 38 | 4.7 | 17 |
| AP4 | 3:1:0.5 | 5.7 | 36 | 5.3 | 28 |
| AP5 | 3:1:0.5 | 6.3 | 42 | 4.9 | 21 |
| AP6 | 3:1:0.5 | 5.4 | 37 | 5.5 | 26 |
| AP7 | 3:1:0.5 | 5.0 | 30 | 6.5 | 25 |

### Extinguishment Tests:

The inventive composition from example 10 was tested for its extinguishing capacity according to European test standard DIN EN 1568:2008, parts 3 (heavy foam on nonpolar fuels) and 4 (heavy foam on polar fuels).

A total of 21 extinguishment tests were carried out, 7 of which were carried out on heptane as the test fuel, 12 on isopropyl alcohol (IPA) and 2 more on acetone. It was found that an extinguishant which comprises the composition from example 10 attains performance class 1A (extinguishment of the test tank within 180 sec on direct application to the liquid and resistance of a reignition source for 10 min) on heptane, and likewise on the two polar test fuels acetone and IPA (extinguishment of the test tank within 180 sec on indirect application and resistance of a reignition source for 15 min). Extinguishment performance class 1A on heptane should be given particular emphasis, in that this is the highest possible extinguishment performance according to this standard. This provides evidence that an extinguishing foam which comprises the inventive composition, in spite of the omission of organofluorine substances, meets the highest performance demands according to DIN EN 1568:2008, and even exceeds them in some cases in direct comparison with AFFF extinguishants.

1. A foam concentrate composition suitable for producing foam extinguishants, comprising
i) at least one fatty alcohol,
ii) at least one acrylic polymer,
iii) at least one thickener and
iv) water,
wherein said composition does not comprise any organofluorine compounds, and wherein foam produced using said concentrate meets or exceeds the DIN EN 1568:2008 standard.

2. The composition according to claim 1, wherein the at least one fatty alcohol is selected from lauryl alcohol, myristyl alcohol and mixtures thereof.

3. The composition according to claim 1, wherein said fatty alcohol is present in an amount of 0.5 to 3% by weight, based on the total weight of the composition.

4. The composition according to claim 1, wherein said acrylic polymer is present in an amount of 0.5 to 5% by weight, based on the total weight of the composition.

5. The composition according to claim 1, wherein the weight ratio of said fatty alcohol to said acrylic polymer is in the range from 1:1 to 1:10.

6. The composition according to claim 1, wherein the amount of thickener (parts by weight) is greater than the amount of acrylic polymer.

7. The composition according to claim 1, wherein the amount of thickener (parts by weight) is greater than the amount of fatty alcohol.

8. The composition according to claim 1, wherein the acrylic polymer is selected from polymers formed from units of polymerized monoethylenically unsaturated monomers M, comprising:
a) at least one monomer A selected from monoethylenically unsaturated mono- and dicarboxylic acids having 3 to 8 carbon atoms and the internal anhydrides of monoethylenically unsaturated dicarboxylic acids having 3 to 8 carbon atoms,
b) at least one monomer B selected from uncharged nonionic monoethylenically unsaturated monomers, and, optionally
c) one or more monomers C which have a sulfonic acid or phosphonic acid group.

9. The composition according to claim 8, wherein the monomers M comprise:
a) 10 to 90% by weight, based on the total amount of the monomers M which constitute the acrylic polymer, of at least one monomer A;
b) 10 to 90% by weight, based on the total amount of the monomers M which constitute the acrylic polymer, of at least one monomer B;
c) 0 to 40% by weight, based on the total amount of the monomers M which constitute the acrylic polymer, of one or more monomers C,
where the total amount of monomers A, B and C amounts to at least 95% by weight of the monomers M which constitute the polymer.

10. The composition according to claim 8, wherein said monomers A are selected from acrylic acid, methacrylic acid, mixtures thereof and mixtures of acrylic acid and/or methacrylic acid with maleic acid.

11. The composition according to claim 8, wherein the monomers B comprise at least one monomer selected from the esters of acrylic acid with C₁-C₁₀-alkanols and the esters of methacrylic acid with C₁-C₁₀-alkanols.

12. The composition according to claim 8, wherein the monomers A are selected from maleic acid and maleic anhydride.

13. The composition according to claim 12, wherein the monomers B comprise at least one monomer selected from the esters of acrylic acid with C₁-C₁₀-alkanols, the esters of methacrylic acid with C₁-C₁₀-alkanols, vinylaromatic hydrocarbons and C₄-C₁₂-olefins.

14. The composition according to claim 8, wherein the monomers B comprise at least one monomer B″.1 which has an ethylenically unsaturated double bond and 1 or 2 poly-C₂-C₄-alkylene ether groups.

15. The composition according to claim 14, wherein the poly-C₂-C₄-alkylene ether groups of the monomers B″.1 are formed to an extent of at least 80% by weight, based on the poly-C₂-C₄-alkylene ether groups, from repeat units of the formula CH₂CH₂O.

16. The composition according to claim 14, wherein the poly-C₂-C₄-alkylene ether groups of the monomers B″.1 have a C₁-C₃₀-alkyl radical or a C₃-C₃₀-alkenyl radical as the end group.

17. The composition according to claim 14, wherein the monomers B″.1 have the general formula I or II 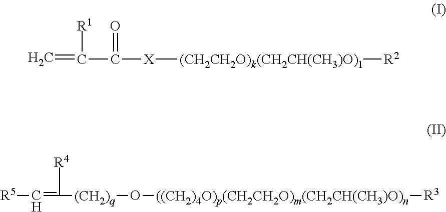
in which the sequence of the repeat units CH₂CH₂O and CH₂CH(CH₃)O is as desired,
k and m are each independently integers from 5 to 100,
l and n are each independently integers from 0 to 100,
where the sum of k plus 1 and the sum of m plus n are each in the range from 5 to 200,
p is 0 or 1;
q is 0 or 1;
R¹ is hydrogen or C₁-C₄-alkyl,
R² is C₁-C₃₀-alkyl or C₃-C₃₀-alkenyl,
R³ is C₁-C₃₀-alkyl or C₃-C₃₀-alkenyl,
R⁴ is hydrogen or C₁-C₄-alkyl,
R⁵ is hydrogen or methyl,
X is O or a group of the formula NR⁶ in which R⁶ is H, C₁-C₆-alkyl, C₃-C₆-alkenyl, C₃-C₆-cycloalkyl, phenyl or benzyl, and is especially hydrogen.

18. The composition according to claim 1, wherein the acrylic polymer is selected from polymers formed from units of polymerized monoethylenically unsaturated monomers A selected from monoethylenically unsaturated mono- and dicarboxylic acids having 3 to 8 carbon atoms and the internal anhydrides of monoethylenically unsaturated dicarboxylic acids having 3 to 8 carbon atoms.

19. The composition according to claim 18, wherein the acrylic polymer is selected from homopolymers of acrylic acid, homopolymers of methacrylic acid, copolymers of acrylic acid with methacrylic acid, copolymers of acrylic acid with maleic acid or maleic anhydride, and copolymers of methacrylic acid with maleic acid or maleic anhydride.

20. The composition according to claim 1, wherein said acrylic polymer has a number-average molecular weight in the range from 1500 to 150 000 daltons.

21. The composition according to claim 1, further comprising 1,2-propylene glycol and/or ethylene glycol.

22. The composition according to claim 1, wherein said composition has a viscosity of 250 to 4000 mPa·s.

23. The composition according to claim 1, wherein said thickener is present in an amount of 2.5 to 4.5% by weight.

24. A method of making a foam extinguishant, comprising foaming a composition according to claim 1 with an aqueous liquid.

25. An apparatus for deploying a foam extinguishant comprising a composition according to claim 1.

26. A method of fighting fires, comprising preparing a foam from a composition according to claim 1 and an aqueous liquid and applying said foam to a fire.

27. A method for fighting fires, comprising:
diluting a composition according to claim 1 with water
foaming the resulting diluted composition to give a foam extinguishant and
applying said foam extinguishant to the seat of fire or to sites which are to be protected from a fire.

28. A foam comprising a composition according to claim 1 and an aqueous liquid.

29. A method of extracting a fossil fuel from a natural underground deposit comprising contacting said fuel in said deposit with a composition according to claim 1 and recovering said fuel.

30. A method of extracting a fossil fuel from a natural underground deposit comprising contacting said fuel with a foam prepared from a composition according to claim 1 and recovering said fuel.
